(19) United States
(12) Patent Application Publication
(10) Pub. No.: US 2005/0084658 A1
(43) Pub. Date: Apr. 21, 2005

(54) Dual contrast embedded mesh for identification of various composite materials

(76) Inventors: Matthew T. Adams, Mason, OH (US); Glenn David Aspenns, Cincinnati, OH (US)

Correspondence Address: ORUM & ROTH, 53 W. JACKSON BLVD, CHICAGO, IL, 60604, US

(21) Appl. No.: 10/689,941

(22) Filed: Oct. 21, 2003

(51) Int. Cl. B32B 3/00

(52) U.S. Cl. 428/195.1

(57) ABSTRACT

An integral label for composite materials. The label, printed with two layers of ink may be embedded on the surface of the composite material using a heat curable resin. The label that provides good contrast with both light or dark colored composite materials. A light colored ink layer being exposed when used with a dark colored composite and the label being reversed to expose a dark colored ink layer when used with a light colored composite.

### FIELD OF THE INVENTION

This invention relates to embedded labels and barcodes. Specifically, this invention relates to embedded labels and barcodes for composite materials that can be used with both dark and light colored composites.

### DESCRIPTION OF RELATED ART

Direct marking of composite materials such as Kevlar, fiberglass, carbon fiber, etc. is difficult for several reasons. First, the data carrier must be very thin and porous to avoid affecting the functionality of the part to be marked. Second, the data carrier must be relatively simple to use. Third, in many applications the marker and/or indicia must be visible against the substrate so that the coding or indicia can be read. Separate labels are used to mark dark and light colored composites. It is desirable to have a carrier that can be used with both light and dark colored composites. This invention eliminates the problems that existing data carriers have with these issues.

One prior art method of making composites is to embed printed fabric into light colored composite materials as a means of marking them for identification purposes. This process involves the encapsulation of a white typewriter-printed fabric within a heat-curable resin on the surface of the item being marked. It does not provide a means of marking dark-colored composite materials. The carrier with dark ink does not provide sufficient contrast on dark surfaces. Similarly, prior art ribbons with excellent contrast on dark surfaces, using lighter colored pigments or reverse printing on a light colored mesh, do not provide enough contrast when adhered to lighter colored surfaces.

The composite part is coated with thermally curable liquid resin that will be baked at a high temperature to reinforce and protect the part. Before the resin is cured, the data carrier is placed onto the liquid resin, adhering the data carrier to the part. A second coating of liquid resin is applied over the data carrier. The resin is then cured. There is a need for a means of marking composite materials for identification that will not affect the functionality of the part. Accordingly, it is another object of the present invention to provide a means for marking composite material that does not affect the functionality of the part and which is simple to use.

There is a need for a single product that can be embedded into a composite part made of either light-colored or dark-colored composite and still provide enough contrast to decode the barcode.

### SUMMARY OF THE INVENTION

The composite components are created by laminating flexible layers of Kevlar, fiberglass, carbon-fiber, etc. with a liquid resin. When the resin cures, the part becomes a hardened stable component. The printed mesh is pressed into the resin before curing or may be applied to a part in a separate later step. Once the resin hardens, the mesh becomes a permanent part of the component. When the mesh is permeated with the liquid resin, it becomes translucent. Any identifying marks on the mesh are visible on the surface of the finished product.

The printed indicia must provide sufficient contrast with the base item. This has been a challenge if use of a single media is desired for embedding in both light and dark surfaces.

An object of this invention is a single product that can be embedded into a composite part made of either light-colored (for example, yellow Kevlar) or dark-colored (for example, carbon composite) composite materials and still provide enough contrast to decode a barcode or other indicia on the carrier mesh.

The inventive carrier is a two layered print ribbon—one ink layer being light-colored and the other ink layer being dark colored. The ribbon is used to print a two-layer symbol, barcode, image or indicia on a mesh carrier. The mesh becomes translucent when permeated by liquid resin, exposing the desired ink layer. The imaged mesh becomes an integral element of the finished component.

When marking light colored substrates with the inventive media construction, the mesh is positioned such that the mesh side contacts the composite and the printed image faces towards the scanner. When marking dark-colored substrates, the media is positioned with the printed image facing the composite and the mesh side up, so that the light-colored ink is facing the scanner. This eliminates having two separate printing systems within the manufacturing area and ensures that a proper image is marked onto the substrates.

With this construction, the printed mesh can be placed onto the part being marked with either the light-colored ink layer (for dark surfaces) or dark-colored ink layer (for light-colored surfaces) facing the user. The mesh becomes translucent when permeated with the resin, thus by simply flipping the printed mesh over, the same construction can be used for both light-colored and dark colored surfaces. This ensures that the scanner, regardless of what color the substrate is, can read every part marked with this construction. Furthermore, this construction eliminates the need for separate ribbons within the manufacturing environment for light-colored substrates and for dark-colored substrates.

### BRIEF DESCRIPTION OF THE DRAWINGS

FIG. 1A is a schematic representation of an expanded cross section of a light composite material with an embedded barcode.

FIG. 1B is a schematic representation of an expanded cross section of a dark composite material with an embedded barcode.

FIG. 2 is a schematic representation of a cross section of a barcode.

FIG. 3 is a schematic representation of the printer ribbon.

FIG. 4 is a schematic representation of a dark colored composite with a barcode.

FIG. 5 is a schematic representation of a light colored composite with a barcode.

FIG. 6 is a printed bar code on the mesh carrier.

FIG. 7 is a bar code on a light colored composite.

FIG. 8 is a bar code on a dark colored composite.

### DETAILED DESCRIPTION OF THE INVENTION

Composite materials 10 are typically formed from at least one reinforcing material and a matrix. The reinforcing material may be, for example, fiber, particulate, or a laminate. Matrix materials may be, for example, ceramic or polymers. Through the selection of variables such as reinforcing material(s), matrix material, composition and reinforcement arrangement composites with a wide range of properties have been developed. Common composite materials are glass-polymer, graphite-polymer, Kevlar-epoxy, Kevlar-polyester and carbon-carbon composites. Polymer and ceramic matrix composites are widely used, for example, in automotive, marine, aircraft, and aerospace components. They are also used in sporting goods, such as tennis rackets, skis, and fishing rods.

Imaged mesh becomes an integral element of the finished component. Composite components are created by laminating flexible layers of Kevlar, fiberglass, carbon-fiber, etc. with a liquid resin. When the resin cures, the part becomes a hardened stable component. The identifying mesh is pressed into the resin before curing. Once the resin hardens, the mesh becomes a permanent part of the component. Alternatively, the data carrier can be attached to the part at a later step. Any identifying marks on the mesh are then visible as a mark in the surface of the finished product. Preferably, when the mesh is permeated with the liquid resin, it becomes translucent.

For applications with visible markers, the marker must provide sufficient contrast with the base item that it can be read. When marking light colored substrates 112 with the inventive media construction, position the mesh 12 is that the printed image and dark ink layer 102 faces towards the scanner. When marking dark-colored substrates 114, flip the stencil over so that the light-colored ink 104 is facing the scanner. The white or light colored layer of ink 104 would be visible through the porous mesh 12 in the finished composite product and the white or light colored layer of ink 104 would provide adequate contrast with the dark substrate 114 to which it is attached. This eliminates having two separate printing systems within the manufacturing area and ensures that a proper image is marked onto the substrates 10.

In a first preferred embodiment a porous mesh 12 is printed with thermal ink that is then adhered to a substrate for direct parts marking. The porous mesh 12 preferably has a thread-count between 180 and 560 threads per inch. Preferably, the carrier is polyester. Alternatively, it could be made of nylon or other known material, capable of being constructed into a porous mesh or other porous material such as paper.

A single thermal transfer ribbon 110 is used to print an image that provides enough contrast for the scanner when the image is adhered to both dark-colored surfaces and light-colored surfaces. This is done by using a special ribbon 110 that is coated with two separate layers of ink, one on top of the other with one ink being light colored and the other being dark-colored. The printer ribbon 110 comprises a light-colored ink/primer layer 102, a dark-colored ink layer 104, a release primer layer (if needed) 106, and PET ribbon carrier 108. The dark colored ink 102 is closest to the printhead. Thus, after the mesh carrier 12 is printed, it has a layered structure. First, there is a dark-colored ink layer 102, next a light-colored ink layer 104, and then the porous mesh 12.

When embedding this construction into a light-colored substrate 112, e.g. yellow Kevlar, fiberglass, etc., the orientation of the mesh would be dark-colored ink layer 102, light-colored ink layer 104, porous polyester mesh 12, and light-colored substrate 112. This orientation of the mesh in relationship with the substrate would provide excellent contrast. The dark-colored ink 102 against the light-colored substrate 112.

For a dark colored substrate 114, e.g. carbon fiber, etc., the carrier mesh 12 is the top layer, the light colored ink 104 is next, then the dark colored ink layer 102 is closest to the dark colored substrate. The printed mesh 12 becomes relatively transparent when permeated with resin, allowing the image printed with the light-colored ink 104 to show through. The light-colored ink layer 104 has sufficient opacity as to obscure the presence of the dark-colored ink layer 102 and the substrate 114. The white or light-colored layer of ink 104 is visible through the porous mesh 12 in the finished composite product and the white or light-colored layer of ink 104 provides adequate contrast with the dark substrate 114 to which it is attached.

A second preferred embodiment uses a reflective ink layer such as a metallic ink is used for the dark-colored ink layer 102. The metallic ink layer has been shown to provide excellent contrast against dark-colored substrates. Magnetic ink character recognition (MICR), uses a reader that can discern characters printed onto non-magnetic materials using magnetic ink in much the same manner as optical character recognition (OCR) scanners use contrast between the black image and the white paper to discern the characters. MICR is used to print the account numbers on the bottom of checks to make them easily scanned. Similar magnetic imaging technology will allow persons to scan machine-readable bar codes.

A third preferred embodiment uses a phosphorescent clear ink that would be visible when viewed under a black light. The scanner can be modified so that it scans at the same wavelength as the black light. In doing so, the security of the symbol could be maintained and the use of counterfeit items could be prevented.

The fourth preferred embodiment would involve pre-printing the porous media using other printing technologies such as screen printing and hot stamp to create the mark. This is useful when one wants to embed static information onto the surfaces to be marked.

A fifth preferred embodiment uses ink jet technology to print dynamic information onto the porous media using two passes. The first pass prints the light-colored ink 104 followed by a second printing of dark-colored ink 102.

The mesh works for embedding because it is thin and porous, allowing surrounding composite material to flow into the pores and bond with the mesh.

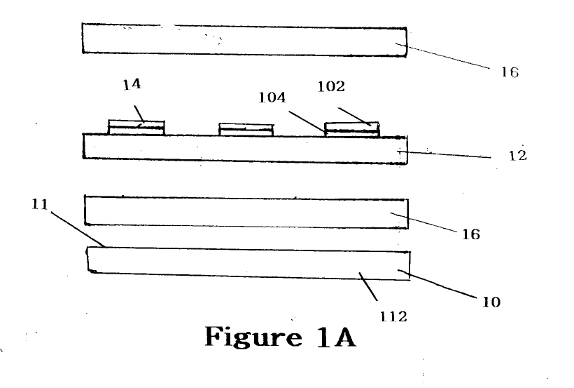

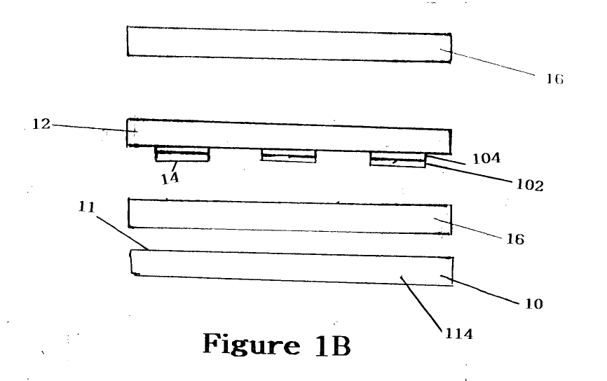

Referring to FIGS. 1A and 1B, composite material with an embedded barcode is shown. The composite material consists of a plurality of layers of composite material 10. Indicia 14 is printed on one surface of the data carrier 12. Preferably, the data carrier 12 is a mesh. More preferably, the data carrier 12 is porous woven mesh. Most preferably, the data carrier 12 is a porous woven mesh that is very thin and porous. The porous woven mesh allows the matrix material of the composite material 10 to flow into the fabric thus bonding the wet mesh with the composite material 10.

The mesh is printed with the appropriate indicia 14. The indicia 14 may be any suitable text, a symbol, bar code or other indication. In the preferred embodiment of the present invention, the indicia 14 is a bar code.

The printed mesh 12 will be embedded in or on the surface 11 of the composite 10 using a heat-curable, resin material. The composite material 10 can be particulate, laminar, chopped fiber, unidirectional or other known composite type. The resin material 16 is preferably selected based on the composite. The preferred resin material is a heat-curable resin. Preferably, the data carrier 12 with printed indicia 14 is placed on the composite 10 during the manufacturing process and the mesh carrier is coated with the heat curable resin 16. Alternatively, the mesh carrier 12 is placed on the composite 10 after the composite has been manufactured. The resin 16 is then coated over the mesh 10. The printed mesh carrier 12 may be embedded on the surface of the part during manufacture of the part of at a later time such as during assembly of a product from the part.

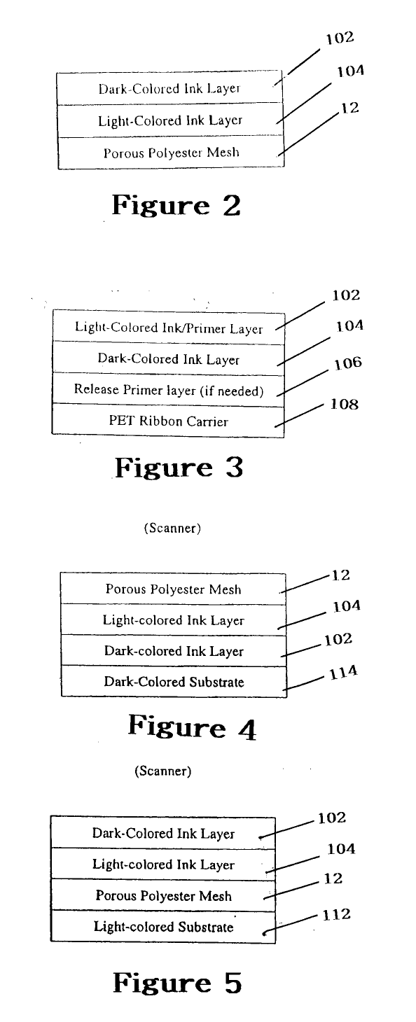

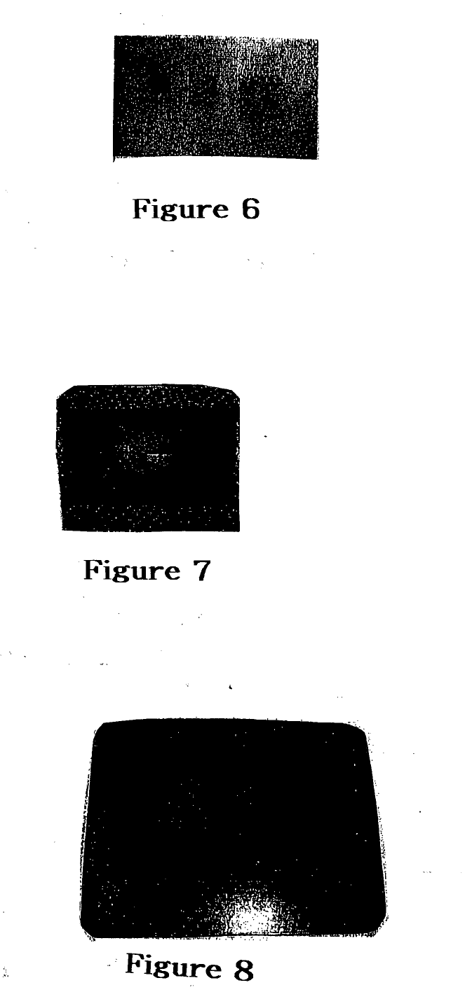

The bar code comprises a porous mesh 12 printed with indicia using a two-layer thermal transfer printer ribbon 110. The ribbon 110 as shown in FIG. 3 is a light colored ink layer 104 or primer layer, a dark colored ink layer 102, a release primer layer 106 if necessary, and a PET carrier ribbon 108. The ribbon 110 is placed in the printer with the dark colored ink layer closest to the print head and the light colored ink layer closest to the mesh 100 substrate to the printed. The printed mesh shown in FIG. 2 thus has light colored ink next to the mesh 12 and dark colored ink 102 on top of the light colored ink 104. Alternatively, the dark ink layer could be next to the mesh and the light ink layer on top of the dark layer. The layered mesh can be used to mark both light and dark colored composites 112, 114.

Referring to FIGS. 1A, 5 and 7, on a light colored composite 112, the printed mesh 12 is placed mesh side down on the composite 112. The dark colored ink 102 is visible. Referring to FIGS. 1B, 4 and 8, on a dark colored composite 114, the printed mesh is placed ink 102 side down. When coated with the resin, the mesh 12 becomes relatively transparent. This allows the image printed with light colored ink 104 to show through. The light colored ink layer 104 has sufficient opacity so as to obscure the presence of the dark-colored ink layer 102 and the substrate. The ink indicia can be read with a bar code reader or scanner.

In an alternative embodiment, the dark-colored ink layer 102 is a metallic ink. Metallic ink has been shown to have good contrast against dark-colored substrates. Alternatively, a single metallic ink layer could be used with light and dark-colored substrates. When metallic ink is used it can be scanned using MICR or other similar technology.

The mesh 12 is preferably made of polyester, but any porous mesh material such as nylon can be used. Preferably, the mesh has about 180 to 560 threads per inch.

In an alternative embodiment, the mesh 12 could be printed by first printing indicia with a light colored ink 104 and then reprint the indicia with a dark-colored ink 102. This embodiment is especially well suited to an ink jet printer. Whereas, the dual layer ink ribbon 110 is especially well suited for a thermal transfer printer.

Alternatively, the porous mesh 12 could be pre-printed with indicia using other printing technologies such as screen printing and/or hot stamping to create the mark. This is useful when the information to be printed is static.

1. A label for use with a composite material comprising:
a carrier with printed ink indicia,
said ink indicia comprised of a first layer of a first ink and second layer of a second ink, and
wherein the carrier becomes one of translucent or transparent when coated with a resin material.

2. The label of claim 1, wherein the carrier is a mesh.

3. The label of claim 1, wherein the carrier is a porous woven mesh, having a thread count between 180 and 560 threads per inch.

4. The label of claim 1, wherein the label is embedded in the surface of the composite material using the resin material.

5. The label of claim 1, wherein the resin material is a heat curable resin.

6. The label of claim 4, wherein the carrier is a mesh, the resin impregnates the mesh and said label becomes integral with the composite material after the resin has cured.

7. The label of claim 4, wherein the carrier is a porous woven mesh having a thread count between 180 and 560 threads per inch.

8. The label of claim 1 wherein the first ink layer comprises a light-colored ink and said second ink layer comprises a dark-colored ink.

9. The label of claim 8 wherein composite is a light colored composite and the carrier contacts the composite.

10. The label of claim 8 wherein the composite is a dark-colored composite and the dark-colored ink layer contacts the composite.

11. The label of claim 10 wherein said light-colored ink layer has sufficient opacity to obscure the dark-colored ink layer and the composite.

12. A thermal transfer ribbon comprising:
a ribbon carrier having a first side with printed ink indicia; said printed ink indicia comprises:
a first ink layer; and
a second ink layer between said ribbon carrier and said first ink layer.

13. A thermal transfer ribbon of claim 12 wherein the first ink layer is a dark colored ink and the second ink layer is a light colored ink.

14. A thermal transfer ribbon of claim 12 wherein the first colored ink layer is a light colored ink and the second colored ink layer is a dark colored ink.

15. The thermal transfer ribbon of claim 12 wherein one ink layer is a light colored ink layer and one ink layer is a dark colored ink layer the light colored ink layer has sufficient opacity to obscure the dark colored ink layer.

16. A method of labeling a composite material the steps of:
obtaining a porous mesh carrier;
printing ink indicia having a first ink layer and a second ink layer on the carrier; and
embedding the carrier into a composite material.

17. The method of claim 16 wherein the ink indicia is printed using a thermal transfer comprising first a ribbon carrier having a first side; a first colored ink layer and a second colored ink layer.

18. The method of claim 16 further comprising the steps of:
placing the printed carrier on the surface of a composite material;
coating the carrier with a resin;
allowing the resin to flow into the mesh; and
curing the resin;
wherein the data is printed using a thermal transfer ribbon having a first ribbon layer of a first ink and a second ribbon layer of a second ink such that the first and second ink layers are printed simultaneously.

19. The method of claim 15 further comprising the steps of placing the carrier such that the carrier contacts the composite.

20. The method of claim 15 further comprising the step of placing the carrier such that the second ink layer contacts the composite.
